(19) United States
(12) Patent Application Publication
(10) Pub. No.: US 2009/0197581 A1
(43) Pub. Date: Aug. 6, 2009

(54) MULTI-VERSION MOBILE ADVERTISEMENTS

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/026,526

(22) Filed: Feb. 5, 2008

(51) Int. Cl. H04M 3/42

(52) U.S. Cl. 455/414.2

(57) ABSTRACT

A method is disclosed for providing mobile publishers with multiple versions of an advertisement, including enabling an advertiser to create at least two different versions of an advertisement, wherein each version is formatted for display on a mobile device with a predetermined device attribute including a screen attribute, and providing a mobile publisher with the at least two versions of the advertisement for service to a plurality of mobile devices having different screen attributes, at least one of the plurality of mobile devices having a screen attribute corresponding to that of at least one of a plurality of advertisement versions.

### TECHNICAL FIELD

The present description relates generally to a system and method, generally referred to as a system, for serving advertisements over mobile devices, and more particularly, but not exclusively, to providing to mobile publishers different versions of advertisements for compatible display on mobile devices having different screen attributes.

### BACKGROUND

The mobile phone may be increasingly important as an information and content access device. Currently there may be over 2 billion mobile phones globally, versus 800 million personal computers. Mobile operators may be increasingly looking to high value data services as a way to overcome the continuing voice Average Revenue Per User (ARPU) decline. Billions of dollars may be being spent globally on wireless licenses with billions more in investments in the pipeline for development of infrastructure and services by wireless service and content providers. Mobile carriers may be introducing new data, content and multimedia services as a means of generating new revenue stream, reversing negative ARPU trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers. As consumer adoption of wireless technology continues to increase, marketing via mobile devices may become an important part of all integrated data communications strategies.

Mobile marketing may benefit consumers, mobile service providers, publishers and advertisers by driving incremental revenue, enhancing consumer loyalty and providing convenience for mobile consumers. Mobile data acceptance may have arrived in many parts of the World and may be expected to increase. Mobile destination portals such as YAHOO! may monetize the mobile searches.

The global business model of mobile marketing to date may depend upon subscription revenue and purchases of consumables (i.e. ring tones, wallpapers, etc.). Slow roll-out and relatively small incremental revenue streams may be jeopardizing return on investment on current and future investments. Wireless advertising may now be seen as the great hope in accelerating revenue growth, especially given the experience of online web advertising. Search may be emerging as both a key feature and a potential universal interface for discovering and accessing mobile information.

However, usage patterns for mobile search and Web search may differ, as well as the expectations of the users and the advertisers. Combined with a completely different user experience, these may change the value of clicks and lead opportunities. Most current mobile devices may have limited browser capabilities that do not support the rich feature set of the Web. Handset capabilities may impact the search behavior of mobile users, where the limitations of numeric-pad keyed entry narrow the searched for terms. The small screen size on mobile devices may have an impact on the performance of the search implementations. The size of screens on mobile handsets may limit the creative that can be displayed per listing, and the number of listings per screen. Current web search marketing systems may not account for these physical differences between mobile handsets and computers.

The mobile market place may be very fragmented in terms of handset and network technologies, and this may impact the display of listings and advertiser offer sites. For mobile devices, there may not be an HTML-like standard adhered to by all carriers, and the “standards” that are present may tend to be operator specific, and may be incompatible with other “standards.” This may lead to markets within markets, where, for example in Japan, advertisers may create separate sites and campaigns for mobile internet service provider (ISP) users, and XHTML and WML users. This fragmentation may also be barrier to entry for advertisers due to the investment required to support the different technologies and interact with each individual carrier. Advertisers may be faced with either a large start-up investment, or foregoing traffic from certain operators.

### SUMMARY

A system is disclosed for providing to mobile publishers different versions of advertisements for compatible display on mobile devices having different screen attributes. According to one aspect, a method is disclosed for providing mobile publishers with multiple versions of an advertisement, including enabling an advertiser to create at least two different versions of an advertisement, wherein each version is formatted for display on a mobile device with a predetermined device attribute including a screen attribute, and providing a mobile publisher with the at least two versions of the advertisement for service to a plurality of mobile devices having different screen attributes, at least one of the plurality of mobile devices having a screen attribute corresponding to that of at least one of a plurality of advertisement versions.

According to another aspect, a method is disclosed for providing mobile publishers with multiple versions of an advertisement, including enabling an advertiser to create at least two versions of an advertisement, wherein each version is formatted for display on a mobile device with a predetermined screen size, wherein one version comprises fewer characters than the other; and providing a mobile publisher with the at least two versions of the advertisement for service to a plurality of mobile devices having different screen attributes.

According to another aspect, a system is disclosed for allowing advertisers to create mobile device ad campaigns, including a memory to store instructions, a mobile carrier data and an advertisement data. An interface is operatively connected to the memory to communicate with advertisers that use a mobile device or a web-based computer. A processor is operatively connected to the memory and the interface to execute the instructions, wherein the processor receives information from an advertiser via the interface, and based on the information creates at least two versions of an advertisement different in at least a number of bytes used to display the advertisement. The processor also provides to a mobile publisher the at least two versions of the advertisement for service of the advertisement to a plurality of mobile devices that may differ in screen attributes.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the Figures, like referenced numerals may refer to like parts throughout the different figures unless otherwise specified.

FIG. 1 is a block diagram of a general overview of a system for creating and serving advertisements over mobile devices.

FIG. 2 is block diagram of a simplified view of a network environment implementing a system for creating and serving advertisements over mobile devices.

FIG. 3 is a flowchart illustrating steps that may be taken by a revenue generator in the systems of FIG. 1 and FIG. 2, or other systems for serving advertisements over mobile devices.

FIG. 4 is a flowchart illustrating steps that may be taken by a user in the systems of FIG. 1 and FIG. 2, or other systems for serving advertisements over mobile devices.

FIG. 5 is an illustration of a general computer system that may be used in a system for enabling revenue generators (or advertisers) to create multiple versions of an advertisement for mobile devices having different screen attributes.

FIG. 6 is a screenshot of a revenue generator's advertisement creation screen in the systems of FIG. 1 and FIG. 2, or other systems for creating advertisements destined for mobile devices.

FIG. 7 is a flowchart of a method for enabling an advertiser to create multiple versions of an advertisement to be provided to mobile publishers that serve the advertisement to varying types of mobile devices.

FIG. 8 is a flowchart of a method for enabling an advertiser to create multiple versions of an advertisement, to select the various mobile publishers that may serve the advertisement to its users, and to manage related ad campaigns.

### DETAILED DESCRIPTION

A system and method, generally referred to as a system, relate to serving advertisements over mobile devices, and more particularly, but not exclusively, to providing to mobile publishers different versions of advertisements for compatible display on mobile devices having different screen attributes. The principles described herein may be embodied in many different forms.

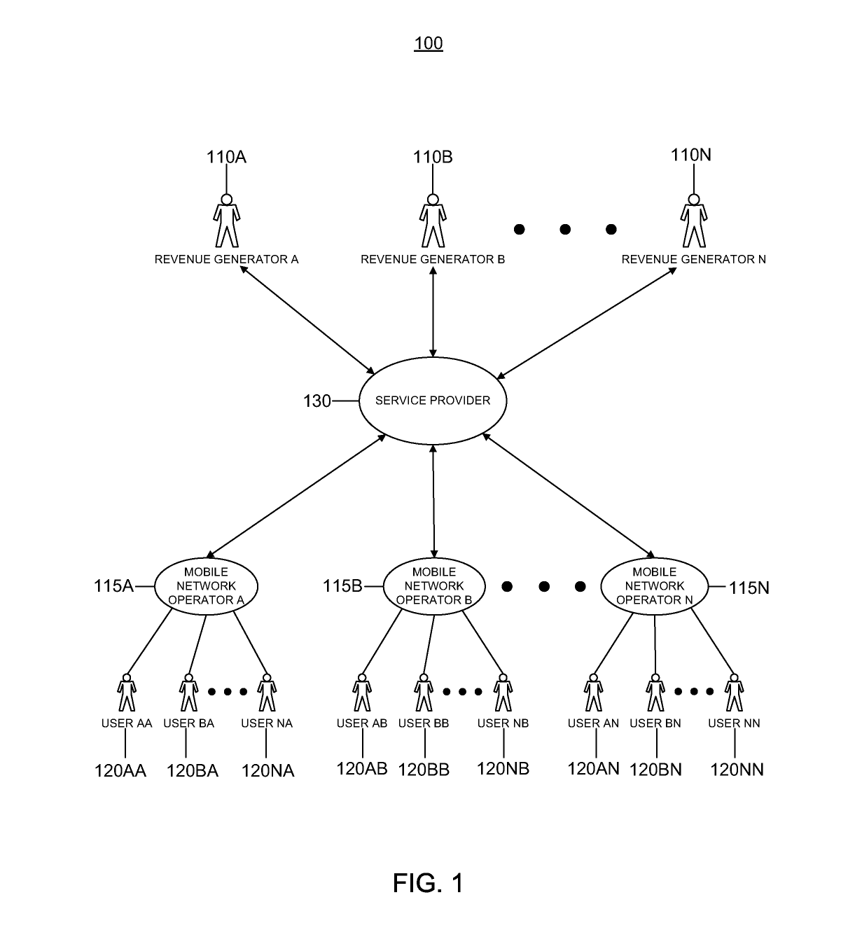

FIG. 1 provides a general overview of a system 100 for serving advertisements over mobile devices. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal, one or more mobile network operators (“MNOs”) 115A-N, more commonly referred to as mobile carriers or simply carriers, and one or more users 120AA-NN, such as mobile subscribers or consumers. The MNOs 115 A-N and the service provider 130 may also be mobile “publishers” to the extent they publish content that display on mobile devices. The revenue generators 110A-N may pay the service provider 130 to display advertisements, such as on-line advertisements on a network such as a mobile network or the Internet. The payments may be based on various factors, such as the number of times an advertisement may be displayed to the users 120AA-NN and/or the number of times one of the users 120AA-NN may click through the advertisement to the revenue generator's web site or mobile site.

The service provider 130 may maintain a mobile site or mobile portal, such as a search site, where the service provider 130 may display advertisements of the revenue generators 110A-N to the users 120AA-NN. The service provider 130 may share revenue with the MNOs 115A-N for displaying advertisements of the revenue generators 110A-N on their mobile networks. Alternatively or in addition the service provider 130 may share revenue with individual mobile publishers for displaying advertisements of the revenue generators 110A-N on their mobile sites.

The users 120AA-NN may be consumers of goods or services who may be searching for a business such as the business of one of the revenue generators 110A-N. The users 120AA-NN may communicate with the service provider 130 through the mobile network operators 115A-N. The users 120AA-NN may supply information describing themselves to the service provider 130, such as the location, gender, or age of the users 120AA-NN, or generally any information that may be required for the users 120AA-NN to utilize the services provided by the service provider 130. Alternatively or in addition the service provider 130 may obtain information about the users 120AA-NN from the MNOs 115A-N.

In the system 100, the revenue generators 110A-N may interact with the service provider 130, such as via a web application. The revenue generators 110A-N may send information, such as billing, website or mobile site and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120AA-NN may also interact individually with the service provider 130, through the mobile network operators 115A-N, such as via a mobile phone or any device capable of communicating with the mobile network operators 115A-N. The users 120AA-NN may interact with the service provider 130 via a mobile web-based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however, the system 100 may apply to any revenue generators 110A-N who may desire to serve advertisements over mobile devices.

In operation, one of the revenue generators 110A-N, such as revenue generator A 110A, may provide information to the service provider 130. This information may relate to the transaction taking place between the revenue generator A 110A and the service provider 130, or may relate to an account the revenue A 110A generator maintains with the service provider 130. In the case of a revenue generator A 110A who is a mobile advertiser, the revenue generator A 110A may provide initial information necessary to open an account with the service provider 130.

A revenue generator A 110A who is an mobile advertiser may maintain one or more accounts with the service provider 130. For each account the revenue generator A 110A may maintain one or more campaigns. For each campaign the revenue generator A 110A may maintain one or more listings. A listing may include a search keyword and one or more carrier listings. Each carrier listing may identify the mobile carrier and may include an advertisement title, an advertisement description, a bid amount and a mobile site URL, if any. A carrier listing may represent an association between a search keyword, a mobile advertisement and a carrier whose users are targeted by the mobile advertisement.

The carrier listings may allow the service provider 130 to provide a mobile advertising marketplace separate from the web advertising marketplace, essentially separating the web keywords from the mobile keywords. The carrier listings may also allow the service provider 130 to provide a separate marketplace for each of the MNOs 115A-N, essentially separating the keywords associated with each of the MNOs 115A-N. For example, the revenue generator A 110A may place one bid on the keyword “dvd” for the MNO A 115A and a separate bid for the keyword “dvd” for the MNO B 115B. Furthermore, by creating a separate marketplace for each of the MNOs 115A-N, the revenue generator A 110A may create separate advertisements compatible with the underlying technology of each MNO.

The service provider 130 may implement the separation of keywords by utilizing a data field to indicate to which carrier a carrier listing may apply. For example, a revenue generator A 110A may have several listings for the same keyword; however, they may be differentiated by a data field indicating to which carrier each listing applies. Alternatively or in addition, if the database architecture does not support the addition of a separate field, or if the service provider 130 wishes to utilize the functionality of an existing web search marketing system, the keywords for each carrier may be separated by adding prefixes to the keywords. In this case, each of the carriers may be identified by a unique prefix identifier. The prefix identifier may include a combination of the geographical location of the carrier and a descriptor of the carrier. For example, the carrier SPRINT may have a prefix of “usmobsprintsb.”

The prefix may be separated from the keyword by a keyword separator, such as the character string “vxv.” The purpose of the keyword separator may be to identify the location in the character string where the prefix ends and the keyword begins. The “vxv” keyword separator may be particularly functional in this regard, because this sequence of letters may very rarely, or never, appear in the English language. Thus, the presence of the “vxv” character string may indicate the end of the prefix and the beginning of the keyword. For example, if the revenue generator A 110A bid on the keyword “dvd” for users on the carrier SPRINT, the keyword may be stored in an existing search marketing database as “usmobsprintsbvxvdvd.” The service provider 130 may later search for the advertisements associated with SPRINT for the keyword “dvd” by searching for the keyword “usmobsprintsbvxvdvd.”

If the revenue generator A 110A does not have a mobile site URL for the MNO A 115A, the revenue generator A 110A may still bid on a keyword for the MNO A 115A. In this case, the service provider 130 may dynamically create a “WAP ad.” The “WAP ad” may be an offer landing page containing the phone number of the advertiser and/or the logo of the advertiser. When a user AA 120AA clicks on the advertisement of the revenue generator A 110A who does not have a mobile site, the user AA 120AA may be taken to a page showing the phone number and/or logo of the revenue generator A 110A. The user AA 120AA may then use their mobile device to call the phone number of the revenue generator A 110A and complete their transaction. The data associated with the “WAP ad” may be stored in the advertisement title and/or the advertisement description fields.

The keywords may represent one or more search terms that the revenue generator A 110A wishes to associate with their advertisement. When a user AA 120AA searches for a search keyword via MNO A 115A, the mobile advertisement of the revenue generator A 110A may be displayed on the search results page. The service provider 130 may also implement directory search implementations, where the user AA 120AA may click through directories of families of related data. In this instance, the search keyword may be the name of the directory on which the user AA 120AA clicks. Alternatively or in addition the user AA 120AA may interact with the service provider 130 through an SMS search service.

For example, a revenue generator A 110A, such as GENERAL MOTORS, may desire to target a mobile advertisement for a GENERAL MOTORS JEEP to users 120AA-NA on MNO A 115A searching for the keywords “JEEP.” GENERAL MOTORS may place a bid with the service provider 130 for the keyword “JEEP” on MNO A 115A. The mobile advertisement of the revenue generator A 110A may be displayed when one of the users 120AA-NA on the MNO A 115A searches for the keyword “JEEP,” or clicks through a directory named “JEEP.” GENERAL MOTORS may be able to use the same interface to submit bids for “JEEP” on any of the MNOS 115A-N.

The advertisement title may represent the data the revenue generator A 110A wishes to be displayed to a user AA 120AA when the user AA 120AA searches for the keyword associated with the listing. Alternatively or in addition, the advertisement description may represent the data the revenue generator A 110A wishes to be displayed to a user AA 120AA when the user AA 120AA searches for the keyword associated with the listing. The mobile site URL may represent the link the revenue generator A 110A wishes a user AA 120AA to be directed to upon clicking on the mobile advertisement of the revenue generator A 110A, such as the home page of the revenue generator A 110A. The bid amount may represent a maximum amount the revenue generator A 110A may be willing to pay each time a user AA 120AA may click on the mobile advertisement of the revenue generator A 110A or each time the mobile advertisement of the revenue generator A 110A may be shown to a user AA 120AA.

There may be some instances where multiple revenue generators 110A-N may have bid on the same search keyword for the same MNO, such as MNO A 115A. The service provider 130 may serve to the users 120AA-NA the online advertisements on which the users 120AA-NA may be most likely to click. For example, the service provider 130 may include a relevancy assessment to determine the relevancy of the multiple mobile advertisements to the search keyword. The more relevant a mobile advertisement may be to the keyword the more likely it may be that the user AA 120AA may click on the advertisement. Exemplary ways to determine relevance are described in more detail below. Methods for assessing relevancy in online web search marketing may also apply to mobile search marketing.

When one of the users 120AA-NN, such as the user AA 120AA, interacts with the service provider 130, such as by searching for a keyword, the service provider 130 may retain data describing the interaction with the user AA 120AA. The retained data may include the keyword searched for, the geographic location of the user AA 120AA, and the date/time the user AA 120AA interacted with the service provider 130. The data may also generally include any data available to the service provider 130 that may assist in describing the interaction with the user AA 120AA, or describing the user AA 120AA. The service provider 130 may also store data that indicates whether a mobile advertisement of one of the revenue generators 110A-N, such as the revenue generator A 110A, was displayed to the user AA 120AA, and whether the user AA 120AA clicked on the mobile advertisement.

The service provider 130 may already have information relating to the geographic location of the user AA 120AA and other information describing the user A 120A, such as gender, age, etc. This information may have been previously supplied to the service provider 130 by the user AA 120AA. Alternatively or in addition, the service provider 130 may obtain the location of the user AA 120AA based on the IP address of the user AA 120AA. The service provider 130 may use a current date/time stamp to store the date/time when the user AA 120AA interacted with the service provider 130. The service provider 130 may use any of the information describing the user or the keyword searched for by the user the relevancy of an advertisement to the search.

Furthermore, the service provider 130 may generate reports based on the data collected from the user interactions and communicate the reports to the revenue generators 110A-N to assist the revenue generators 110A-N in measuring the effectiveness of their mobile advertising. The reports may indicate the number of times the users 120AA-NN searched for the keywords bid on by the revenue generators 110A-N, the number of times a mobile advertisement of the revenue generators 110A-N was displayed to the users 120AA-NN, and the number of times the users 120AA-NN clicked through on the advertisements of the revenue generators 110A-N. There may be a separate report for each MNO 115A-N for which the revenue generator A 110A maintains a carrier listing. There may be a report displaying the aggregate data across all of the MNOs 115A-N for which the revenue generator A 110A maintains an carrier listing. The reports may also generally indicate any data that may assist the revenue generators 110A-N in measuring the effectiveness of their mobile advertising campaigns.

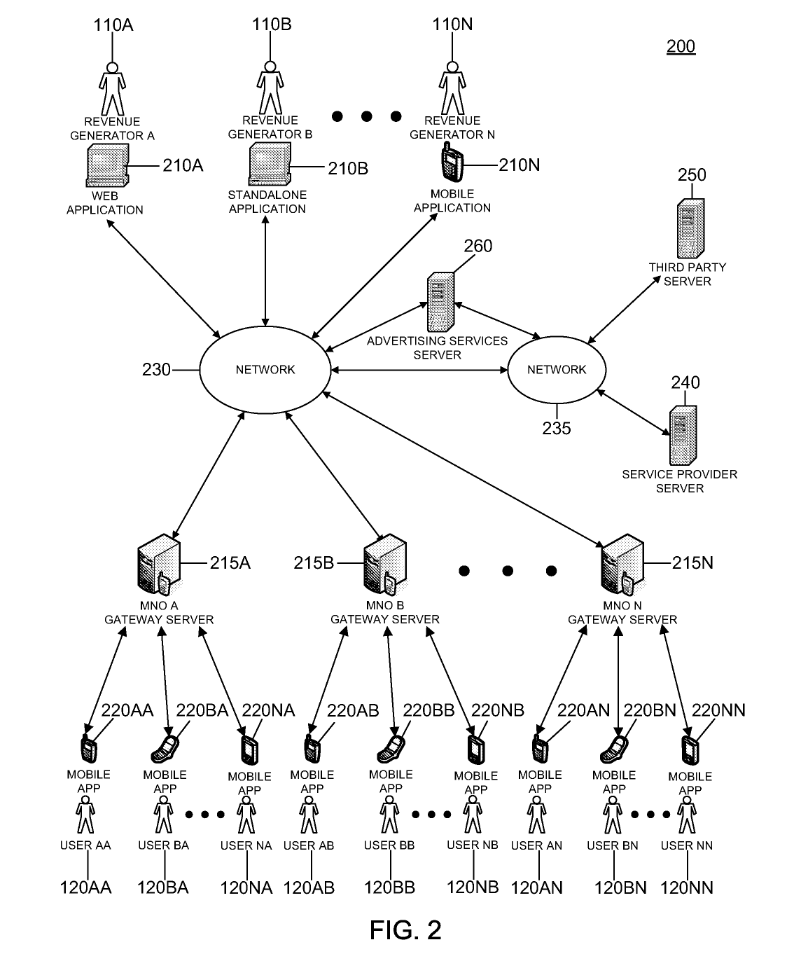

FIG. 2 provides a simplified view of a network environment implementing a system 200 for serving advertisements over mobile devices. Not all of the depicted components may be required, however, and some implementations may include additional components not shown in FIG. 2. Variations in the arrangement and type of the components may be made without departing from the spirit or scope of the disclosure. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps 220AA-NN, which may collectively be referred to as client applications of the users 120AA-NN, or individually as a user client application. The system 200 may also include one or more MNO gateway servers 215A-N, a network 230, a network 235, the service provider server 240, a third party server 250, and an advertising services server 260.

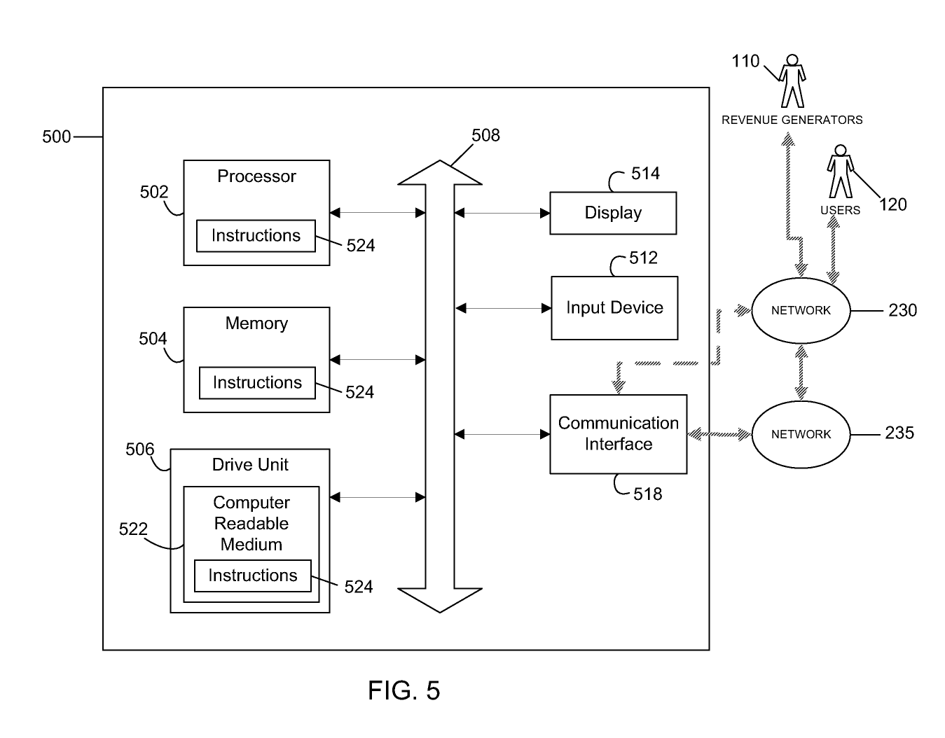

Some or all of the advertisement services server 260, service provider server 240, and third-party server 250 may be in communication with each other by way of network 235 and may be the system or components described below in FIG. 5. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The networks 230, 235 may include wide area networks (WAN), such as the Internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235 through the web applications, standalone applications or mobile applications 210A-N.

The users 120AA-NN may use a mobile application 220AA-220NN, such as a mobile web browser, to communicate with the service provider server 240 via the MNO gateway servers 215A-N and the networks 230, 235. The service provider server 240 may communicate to the users 120A-N via the networks 230, 235 and to the MNOs 215A-N through the mobile applications 220AA-NN.

The web applications, standalone applications and mobile applications 210A-N, 220AA-NN may be connected to the network 230 in any configuration that supports data transfer. This may include a data connection to the network 230 that may be wired or wireless. Any of the web applications, standalone applications and mobile applications 210A-N, 220AA-NN may individually be referred to as a client application. The web application 210A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with a revenue generator A 110A. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile applications 210N, 220AA-NN may run on any mobile device which may have a data connection. The mobile applications 210N, 220AA-NN may be a web application 210A, a standalone application 210B, or a mobile browser. The mobile device may be one of a broad range of electronic devices which may include mobile phones, PDAs, and laptops and notebook computers. The mobile device may have a reduced feature set, such as a smaller keyboard and/or screen, and may be incapable of supporting a traditional web search.

The data connection of the mobile device may be a cellular connection, such as a GSM/GPRS/WCDMA connection, a wireless data connection, an Internet connection, an infra-red connection, a Bluetooth connection, or any other connection capable of transmitting data. The data connection may be used to connect directly to the network 230, or to connect to the network 230 through the MNO gateway servers 215A-N. The MNO gateway servers 215A-N may control the access that the mobile applications 210AA-NN may have to the network. The MNO gateway servers 215A-N may also control the technology supporting the respective mobile applications 220AA-NN. This may affect all aspects of the user experience, such as signal strength and availability, speed and billing mechanisms. For example, the MNO gateway server A 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile applications 220AA-NN may only support one of the aforementioned formats.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. The advertising services server 260 may provide a platform for the inclusion of advertisements in pages, such as web pages or mobile pages. The advertisement services server 260 may be used for providing mobile advertisements that may be displayed to the users 120AA-NN.

The service provider server 240, the third party server 250 and the advertising services server 260 may be one or more computing devices of various kinds, such as the computing device in FIG. 5. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120A-N and the revenue generators 110A-N. The advertising services server 260 may provide a platform for the inclusion of advertisements in pages, such as web pages. The advertising services server 260 may also exist independent of the service provider and the third party servers 240, 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

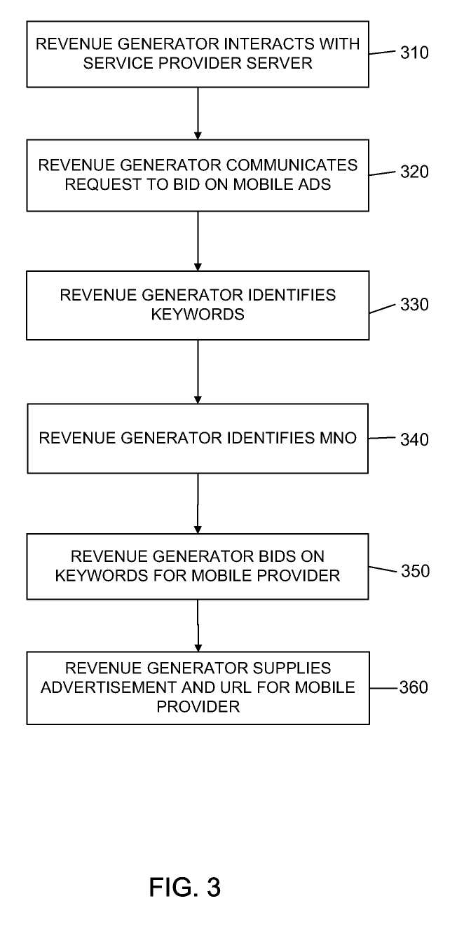

FIG. 3 is a flowchart illustrating steps that may be taken by one of the revenue generators 110A-N in the systems of FIG. 1, and FIG. 2, or other systems for serving advertisements over mobile devices. The steps may occur when one of the revenue generators 110A-N, such as the revenue generator A 110A, wishes to bid on keywords for a carrier, such as the MNO A 115A. At block 310 the revenue generator A 110A interacts with the service provider server 240, such as by logging onto the service provider 130. At block 320 the revenue generator A 110A may communicate a request to bid on mobile keywords.

At block 330, the revenue generator A 110A may communicate information identifying the keyword the revenue generator A 110A wishes to bid on. At block 340, the revenue generator A 110A may identify one or more MNOs 115A-N, such as the MNO A 115A, that the revenue generator A 110A wishes to bid for the keyword on. Once the revenue generator A 110A identifies one or more MNOs 115A-N, the system 100 may move to block 350. At block 350, the revenue generator A 110A may place a bid on the identified keyword for the MNO A 115A. The bid made by the revenue generator A 110A may only apply to the keyword when searched for on the MNO A 115A. The revenue generator A 110A may specify one or more other MNOs 115B-N which the bid may apply to.

At block 360, the revenue generator A 110A may communicate to the service provider 130 a mobile advertisement and a mobile URL to which the advertisement may link. The mobile advertisement may consist of a description of the advertisement and/or a title of the advertisement. The limited space available on the screens of mobile devices may necessitate that a mobile advertisement be relatively shorter than a web advertisement. Alternatively or in addition, the advertisement may include other elements, such as images, audio, and/or video elements (together “creatives”). If the revenue generator A 110A does not have a mobile URL for the MNO A 115A, the service provider 130 may generate a “WAP ad” for the revenue generator A 110A. The “WAP ad” may be a mobile page for the MNO that contains the phone number and/or the logo of the revenue generator A 110A. The “WAP ad” data may be stored in the advertisement description field of the MNO listing of the revenue generator A 110A.

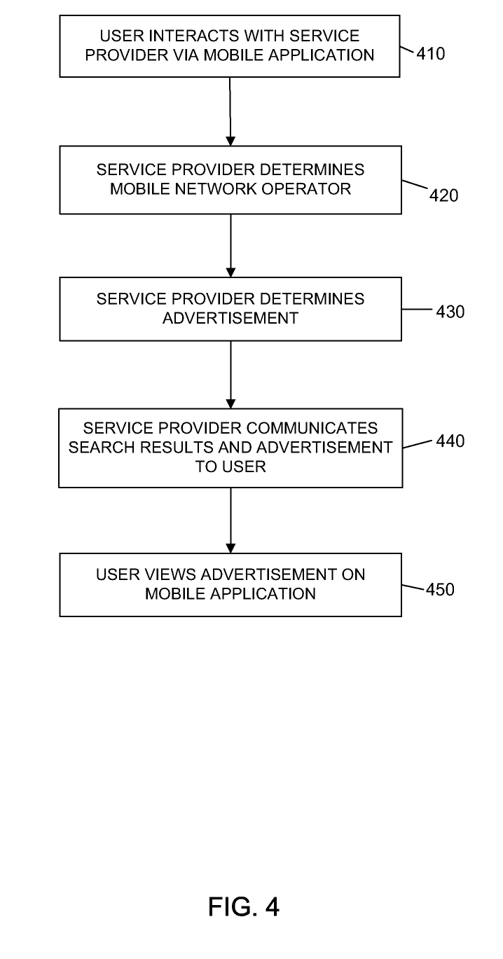

FIG. 4 is a flowchart illustrating steps that may be taken by one of the users 120AA-NN in the systems of FIG. 1, and FIG. 2, or other systems for serving advertisements over mobile devices. The steps may occur when one of the users 120AA-NN, such as the user AA 120AA, performs a search on a mobile application 220AA-NN via a MNO 115A-N, such as the MNO A 115A. At block 410, the user AA 120AA may interact with the service provider 130 via the mobile application AA 220AA, such as by performing a search from the mobile application AA 220AA. At block 420, the service provider 130 may determine the carrier the request of the user AA 120AA originates from, such as the MNO A 115A. At block 430, the service provider 130 may determine which advertisements may relate to the keyword searched for on the MNO A 115A. The service provider 130 may select advertisements from revenue generators 110A-N who may have bid on the keyword searched for from the MNO A 115A. The service provider 130 may select the revenue generator A 110A with the highest bid for the keyword from the MNO A 115A. Alternatively or in addition the service provider 130 may select more than one advertisement to display to the user AA 120AA. The size of the screen on the device of the user AA 120AA may be a factor used in determining how many advertisements to communicate to the user AA 120AA.

At block 440, the service provider 130 may communicate the advertisement and search results to the user AA 120AA via the MNO A 115A and the mobile application AA 220AA. At block 450, the user AA 120AA may view the search results and accompanying advertisement via the mobile application AA 220AA.

FIG. 5 illustrates a general computer system 500, which may represent a service provider server 240, a third party server 250, an advertising services server 260, a mobile device or any of the other computing devices referenced herein. The computer system 500 may include a set of instructions 524 that may be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 524 (sequential or otherwise) that specify actions to be taken by that machine. In a particular embodiment, the computer system 500 may be implemented using electronic devices that provide voice, video or data communication. Further, while a single computer system 500 may be illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, such as, a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 504 may include a cache or random access memory for the processor 502. Alternatively or in addition, the memory 504 may be separate from the processor 502, such as a cache memory of a processor, the system memory, or other memory.

The memory 504 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 504 may be operable to store instructions 524 executable by the processor 502. The functions, acts or tasks illustrated in the Figures or described herein may be performed by the programmed processor 502 executing the instructions 524 stored in the memory 504. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 500 may further include a display 514, such as a liquid crystal display (LCD), an organic light emitting diode (OLED), a flat panel display, a solid state display, a cathode ray tube (CRT), a projector, a printer or other now known or later developed display device for outputting determined information. The display 514 may act as an interface for the user to see the functioning of the processor 502, or specifically as an interface with the software stored in the memory 504 or in the drive unit 506.

Additionally, the computer system 500 may include an input device 512 configured to allow a user to interact with any of the components of system 500. The input device 512 may be a number pad, a keyboard, or a cursor control device, such as a mouse, or a joystick, touch screen display, remote control or any other device operative to interact with the system 500.

The computer system 500 may also include a disk or optical drive unit 506. The disk drive unit 506 may include a computer-readable medium 522 in which one or more sets of instructions 524, e.g. software, can be embedded. Further, the instructions 524 may perform one or more of the methods or logic as described herein. The instructions 524 may reside completely, or at least partially, within the memory 504 and/or within the processor 502 during execution by the computer system 500. The memory 504 and the processor 502 also may include computer-readable media as discussed above.

The present disclosure contemplates a computer-readable medium 522 that includes instructions 524 or receives and executes instructions 524 responsive to a propagated signal; so that a device connected to a network 230 or a network 235 may communicate voice, video, audio, images or any other data over the networks 230, 235 (together “network 235”). The instructions 524 may be implemented with hardware, software and/or firmware, or any combination thereof. Further, the instructions 524 may be transmitted or received over the network 235 via a communication interface 518.

The communication interface 518 may be a part of the processor 502 or may be a separate component. The communication interface 518 may be created in software or may be a physical connection in hardware. The communication interface 518 may be configured to connect with a network 235, external media, the display 514, or any other components in the system 500, or combinations thereof. The connection with the network 235 may be a physical connection, such as a wired Ethernet connection or may be established wirelessly as discussed below. Likewise, the additional connections with other components of the system 500 may be physical connections or may be established wirelessly. In the case of a service provider server 240, a third party server 250, an advertising services server 260, the servers may communicate with users 120A-N and the revenue generators 110A-N through the communication interface 518.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 522 may be a single medium, or the computer-readable medium 522 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 522 may include a solid-state memory such as a memory card or other package that houses one or more non-volatile read-only memories. The computer-readable medium 522 also may be a random access memory or other volatile re-writable memory. Additionally, the computer-readable medium 522 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

As mobile devices become smaller and more compact, the amount of information they need to convey increases. The convergence of functions and constant addition of features create layers of complexity in navigation and usability of mobile user interfaces. Mobile designers and developers need to understand how to create the best user experience possible within these constraints. Unlike the desktop web environment, the mobile web has an entirely different set of user requirements to consider.

Accordingly, serving advertisements to mobile devices is a challenge because of their level of fragmentation and proliferation. As a result of such fragmentation and proliferation, there is a massive variation in device attributes that may present particular challenges to mobile designers and developers of advertising content destined for different types of mobile devices. The device attributes may vary in many ways, including but not limited to: screen resolution; type of CPU; memory; input mechanisms; operating systems; manufactures; and mobile carrier-specific applications and services. Furthermore, components of the user interface are the visual display and screen attributes, and the response/input methods that include input keys and soft keys, which are programmable and available on every handset, along with stylus touch screens and QWERTY keyboards. For the visual display, components include navigational menus, icons, graphics, text, and display screen. The specific screen attributes may further include, for instance: display size; resolution; brightness; color; touch screens; and alternative input methods for graphics and text, such as audio inputs and buttons for camera and web browsing activation.

There is, additionally, an endless stream of new devices or “publish targets” for which developers have to author. Research indicates that authoring (or professional media) companies targeting mobile devices spend substantial sums each year buying and analyzing all the phones that come to market.

In accordance with the present embodiments, there are ways in which mobile carriers or service providers can enable advertisement designers and developers to create versions of the same advertisement that vary in technical characteristics to be compatible with mobile devices of different attributes. One of those attributes, as discussed, is screen size or resolution; various advertisements may be created for different sizes and resolutions of screens that a service provider may target. While the present embodiments focus on multiple versions of advertisements to fit on screens of different size and resolution, other attributes as discussed above may be considered when creating, simultaneously, versions of the same advertisement to adapt to varying device and screen attributes.

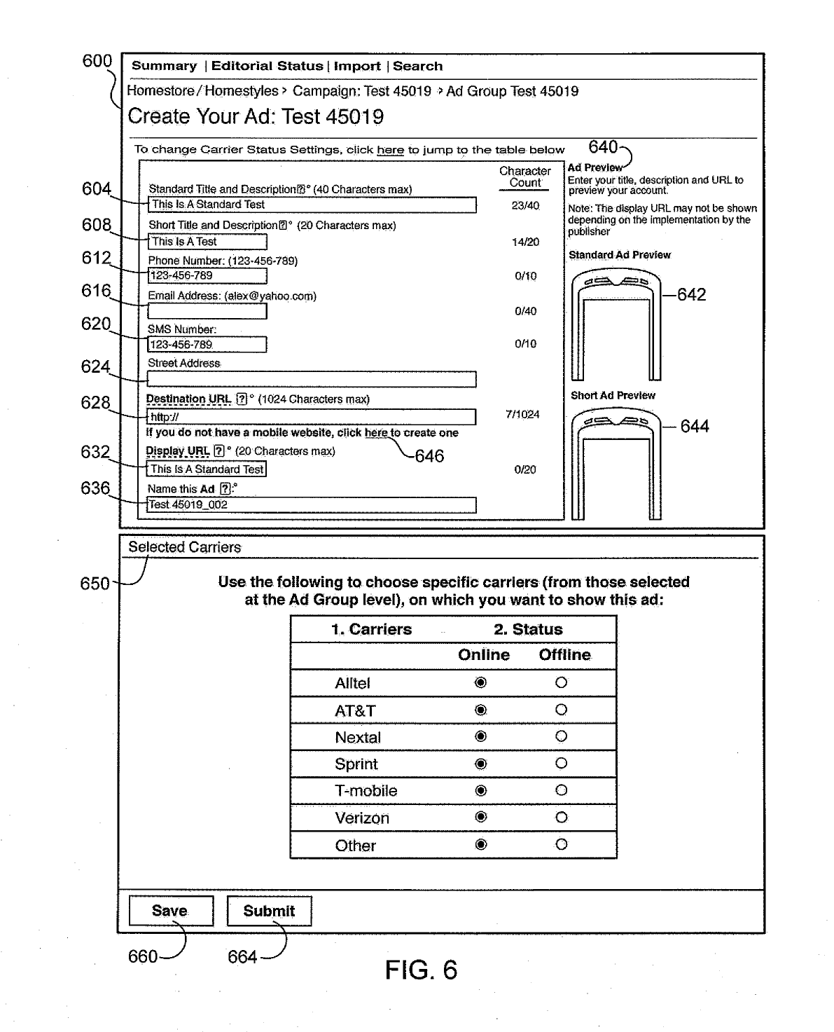

FIG. 6 is a screenshot of a revenue generator's advertisement creation screen 600 in the systems of FIG. 1 and FIG. 2, or other systems for creating advertisements destined for mobile devices. After a bid specification step, advertisers are prompted to create an advertisement that will be served on mobile devices. The ad creation screen 600 may include a plurality of data input fields to enable an advertiser, or a revenue generator (110A in FIG. 1), to input ad-related information to enable creation of an advertisement. The fields may include, but are not limited to, a standard title and description field 604, a short title and description field 608, a phone number field 612, an e-mail address field 616, a short message service (SMS) address field 620, a street address field 624, a destination uniform resource locator (URL) field 628, a display URL field 632, and advertisement name field 636. The advertisement name field 636 enables the advertiser to give this particular advertisement a name to be able to track it through reports of performance and billing.

The standard title and description field 604 enables creation of a longer advertisement having more characters viewable on a mobile device. For instance, the advertisement may be as long as 40 characters or longer and span over two lines or more of display on the mobile device. The short title and description field 608 is to enable creation of a shorter version of the same advertisement viewable on a mobile device taking up fewer characters, for instance, 20 characters. The phone number, e-mail address, SMS number, and street address fields (612-624) are generally required at the ad-level and are optional but nice-to-have at the account-level.

The destination URL field 628 is to enable the advertiser to input the destination URL, and the display URL field 632 to enable the advertiser to input the display URL, related to the advertisement being created. There may be a difference between the destination and display URLs. The display URL is the URL that appears below ad text when an advertisement is shown. The display URL is often the same URL as an advertiser's homepage (e.g. www.Example.com). The destination URL, on the other hand, is the specific location within the website where the advertiser would like to take a user that has clicked on the advertisement. The destination URL does not have to match the display URL, but should be in the same domain, e.g., www.example.com/shoes. If a display URL is equivalent to the company name sign, the destination URL is the particular location within the store (e.g. the shoe section) that an advertiser wants users to visit. This allows for directing of the users 120AA-NN to pages within an advertiser's website that are most relevant to the selected advertisement.

Table 1 displayed below is a summary of a possible breakdown of the fields displayed in FIG. 6, and current suggested character length limitations.

| | Japan | United Kingdom | United States |
|---|---|---|---|
| Standard T & D | 15 characters in | Alphanumeric; 40 | Alphanumeric; 40 |
| | double byte characters | characters | characters |
| | (TITLE) | | |
| Short T & D | 10 characters in | Alphanumeric; 20 | Alphanumeric; 20 |
| | double byte characters | characters | characters |
| | (DESC) | | |
| Destination URL | 300 characters | 1024 characters | 1024 characters |
| Display URL | 50 characters | 20 characters | 20 characters |
| | (including http://) | (including http://) | (including http://) |
| Phone Number | Numeric; 15 digits | Numeric; 11 digits | Numeric; 10 digits |
| E-mail Address | Alphanumeric; 40 | Alphanumeric; 40 | Alphanumeric; 40 |
| | characters | characters | characters |
| SMS Number | Numeric; 15 digits | Numeric; 10 digits | Numeric; 10 digits |
| Street Address | Single field to capture | Single filed to capture | Single field to capture |
| | full address | full address | full address |

As an advertiser fills in the fields of the ad creation screen 600, an ad preview field 640 area will be populated to display how the standard sized advertisement (642) and the short sized advertisement (644) will look on an exemplary device. The display URL may not be shown depending on the implementation by the publisher.

If an advertiser does not have his or her own website to which to direct user traffic from an advertisement, that advertiser will still create all the components of the advertisement on the main ad creation screen 600 except for the destination and display URLs. Instead, the advertiser will click on a microsite link 646, which will lead the advertiser to a landing page (not shown) through which the advertiser may create a Call Offer, similar to a “WAP ad” as referred to earlier. The landing page (or mobile microsite) will include an offer text, the provided phone number from field 612 or other contact information, and possibly a logo (not shown) that may be uploaded onto the mobile microsite. The microsite will have its own unique destination URL and display URL which will then be populated into the respective fields 628 and 632 on the main ad creation screen 600 when the advertiser saves or submits the advertisement data.

Additionally, through a select carriers field 650, the advertiser is able to indicate whether the advertisement must be used for all the carriers that they selected for an advertisement group (or “ad group”) targeted by the advertising campaign including the advertisement. The advertisers will be able to create multiple advertisements, and will be able to specify whether the advertisements should be optimized for serving. A save button 660 and a submit button 664 are provided to enable the advertiser to save the advertisement data throughout the process, and to finally submit the entire advertisement to be created when complete.

After submission of the advertisement to be created, the advertiser is taken to a review screen (not shown) that displays an overview of the ad group created from the select carriers field 650. The overview may include the advertisement name, the selected mobile carriers, the bids affiliated with the advertisement, a number of keywords, and a number of advertisements related to the ad group. Additionally displayed may include forecast data such as average CPC and estimated searches. Advertisers should be allowed click-to-edit functionality in case they want to change any specifications for their ad group. Once satisfied with the ad group, advertisers will go to the campaign budgeting and scheduling step (not shown) where they can specify a daily and/or monthly budget if they so choose, and specify a schedule, such as a start and an end date, for the campaign.

Finally, the advertisers are allowed to submit or otherwise activate their advertising campaign including all the advertisements related to an ad group. The mobile carrier or service provider 130 may then send an e-mail acknowledgement or the like that the new campaign has been created.

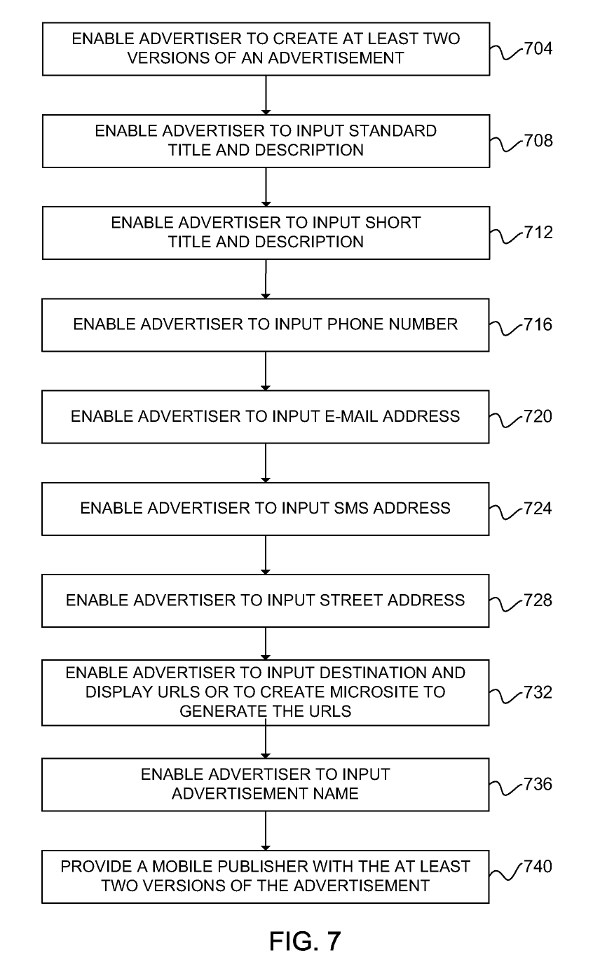

FIG. 7 is a flowchart of a method for enabling an advertiser to create multiple versions of an advertisement to be provided to mobile carriers that serve the advertisement to varying types of mobile devices. At block 704, an advertiser is enabled to create at least two versions of an advertisement, e.g., via advertisement creation screen 600. At block 708, the advertiser is enabled to input a standard title and description of the advertisement. At block 712, the advertiser is enabled to input a short title and description of the advertisement. At block 716, the advertiser is enabled to input his or her phone number. At block 720, the advertiser is enabled to input his or her e-mail address. At block 724, the advertiser is enabled to input his or her short message service (SMS) address. At block 728, the advertiser is enabled to input his or her street address.

At block 732, the advertiser is enabled to input a destination and a display uniform resource locator (URL) affiliated with the advertisement or to create a microsite that generates the URLs where the advertiser does not have his or her own website. Where the microsite is created, the generated URLs will provide a landing page in response to a user clicking on an advertisement affiliated with the URLs as discussed above, enabling the user to contact the advertiser and complete a sales transaction. At block 736, the advertiser is enabled to input an advertisement name. At block 740, a mobile publisher is provided with at least two versions of the advertisement, e.g., one version related to the standard sized advertisement and the other related to a short sized advertisement.

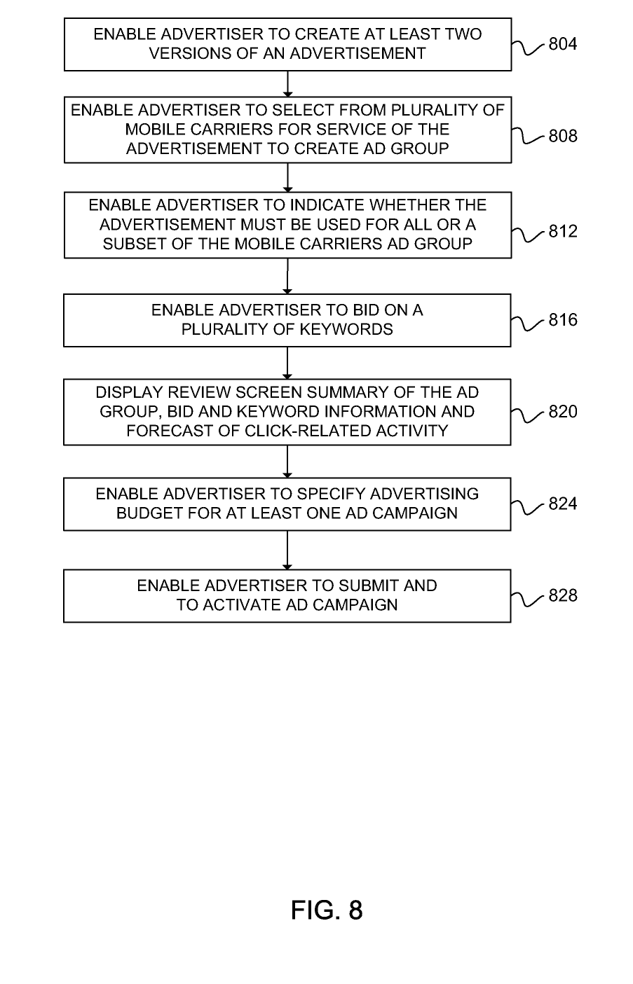

FIG. 8 is a flowchart of a method for enabling an advertiser to create multiple versions of an advertisement, to select the various mobile carriers that may serve the advertisement to its users, and to manage related ad campaigns. At block 804, an advertiser is enabled to create at least two versions of an advertisement, such as through the method described in FIG. 7. At block 808, the advertiser is enabled to select from a plurality of mobile carriers (e.g., mobile network operators 115A-N or mobile publishers) to create an ad group to which the advertisement will have coverage. At block 812, the advertiser is enabled to indicate whether the advertisement must be used for all or a subset of the ad group of mobile carriers. At block 816, the advertiser is enabled to bid on a plurality of key words. At block 820, the advertiser is enabled to display a review screen summary of the ad group including the selected carriers and at least one of bids, keywords, a number of ads, and a forecast of click-related data as discussed above. At block 824, the advertiser is enabled to specify an advertising budget for at least one ad campaign. At block 828, the advertiser is enabled to submit and activate the at least one ad campaign.

The order of the steps or actions of the methods described in connection with the disclosed embodiments may be changed as would be apparent to those skilled in the art. Thus, any order appearing in the Figures, such as in flow charts or in the Detailed Description is for illustrative purposes only and is not meant to imply a required order. The methods may also be implemented by software programs executable by a computer system. Further, implementations may include distributed processing, component/object distributed processing, and parallel processing. Alternatively or in addition, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of providing mobile publishers with multiple versions of an advertisement, comprising:
enabling an advertiser to create at least two different versions of an advertisement, wherein each version is formatted for display on a mobile device with a predetermined device attribute including a screen attribute; and
providing a mobile publisher with the at least two versions of the advertisement for service to a plurality of mobile devices having different screen attributes, at least one of the plurality of mobile devices having a screen attribute corresponding to that of at least one of a plurality of advertisement versions.

2. The method of claim 1, wherein the screen attribute comprises a screen size or resolution, and wherein the at least two different versions of the advertisement comprise one advertisement of a length in characters longer than the length in characters of another advertisement.

3. The method of claim 2, further comprising:
enabling the advertiser to input a destination uniform resource locator (URL) and a display URL to be affiliated with the at least two versions of the advertisement.

4. The method of claim 2, further comprising:
enabling the advertiser to create a mobile microsite including offer text and a phone number or other contact information;
generating unique destination and display uniform resource locators (URLs) to be associated with the mobile microsite; and
enabling the advertiser to create the two versions of the advertisement with the generated unique destination and display URLs.

5. A method of providing mobile publishers with multiple versions of an advertisement, comprising:
enabling an advertiser to create at least two versions of an advertisement, wherein each version is formatted for display on a mobile device with a predetermined screen size, wherein one version comprises fewer characters than the other; and
providing a mobile publisher with the at least two versions of the advertisement for service to a plurality of mobile devices having different screen attributes.

6. The method of claim 5, wherein the at least two versions of the advertisement comprise at least two versions of a creative having different byte sizes.

7. The method of claim 5, wherein enabling the creation of the at least two versions of the advertisement comprises:
enabling the advertiser to input a standard title and a description to create a standard sized advertisement; and
enabling the advertiser to input a short title and description to create a short sized advertisement.

8. The method of claim 7, further comprising:
enabling the advertiser to input destination and display uniform resource locator (URLs) for the two versions of the advertisement.

9. The method of claim 7, further comprising:
enabling the advertiser to input at least one of a phone number and a street address; and
enabling the advertiser to input a short message service (SMS) address.

10. The method of claim 7, further comprising:
enabling the advertiser to create a mobile microsite including offer text and a phone number or other contact information.

11. The method of claim 5, further comprising:
enabling the advertiser to select from a plurality of mobile carriers to create an ad group to which the advertisement will have coverage; and
enabling the advertiser to indicate whether the advertisement must be used for all the selected carriers or just a subset of the selected carriers.

12. The method of claim 11, further comprising:
enabling the advertiser to bid on a plurality of keywords with relation to the advertisement and with relation to additional advertisements.

13. The method of claim 12, further comprising:
displaying a review screen summary of the ad group comprising the selected carriers and at least one selected from the group consisting of bids, keywords, a number of ads, and a forecast of click-related data.

14. The method of claim 12, further comprising:
enabling the advertiser to specify an advertising budget for at least one ad campaign related to the advertisements.

15. A system for allowing advertisers to create mobile device ad campaigns, comprising:
a memory to store instructions, a mobile carrier data and an advertisement data;
an interface operatively connected to the memory to communicate with advertisers that use a mobile device or a web-based computer; and
a processor operatively connected to the memory and the interface to execute the instructions, wherein the processor receives information from an advertiser via the interface, and based on the information creates at least two versions of an advertisement different in at least a number of bytes used to display the advertisement;
wherein the processor provides to a mobile publisher the at least two versions of the advertisement for service of the advertisement to a plurality of mobile devices that may differ in screen attributes.

16. The system of claim 15, wherein the processor enables the advertiser to create a mobile microsite including offer text and a phone number or other contact information.

17. The system of claim 16, wherein the processor accepts upload of a logo from the advertiser through the interface for display on the mobile microsite.

18. The system of claim 16, wherein the processor generates unique destination and display uniform resource locators (URLs) to be associated with the mobile microsite and inputs them into the interface for submission by the advertiser during ad creation.

19. The system of claim 15, wherein the processor:
enables the advertiser to input a standard title and a description to create a standard sized advertisement; and
enables the advertiser to input a short title and description to create a short sized advertisement.

20. The system of claim 19, wherein the processor enables the advertiser to input a destination uniform resource locator (URL) and a display URL for the two versions of the advertisement.

21. The system of claim 19, wherein the processor enables the advertiser to input at least one of a phone number, a street address, and a short message service (SMS) address.

22. The system of claim 19, where the processor:
enables the advertiser to select from a plurality of mobile carriers to create an ad group to which the advertisement will have coverage; and
enables the advertiser to indicate whether the advertisement must be used for all the selected carriers or just a subset of the selected carriers.

23. The system of claim 22, wherein the processor enables the advertiser to bid on a plurality of keywords with relation to the advertisement and with relation to additional advertisements.

24. The system of claim 23, wherein the processor enables the advertiser to specify an advertising budget for at least one ad campaign related to the advertisements.

25. The system of claim 23, wherein the processor displays a review screen summary to the advertiser through the interface, wherein the review screen summary includes the ad group comprising the selected carriers and at least one selected from the group consisting of bids, keywords, a number of ads, and a forecast of click-related data.
